(19) United States
(12) Patent Application Publication
(10) Pub. No.: US 2025/0022255 A1
(43) Pub. Date: Jan. 16, 2025

(54) IMAGE PROCESSING APPARATUS

(71) Applicant: SUBARU CORPORATION, Tokyo (JP)

(72) Inventor: Yohei OHKAWA, Tokyo (JP)

(73) Assignee: SUBARU CORPORATION, Tokyo (JP)

(21) Appl. No.: 18/761,413

(22) Filed: Jul. 2, 2024

(30) Foreign Application Priority Data
Jul. 13, 2023 (JP) 2023-115066

(51) Int. Cl. G06V 10/77; G06V 10/82; G06V 20/58

(52) U.S. Cl. CPC G06V 10/7715; G06V 10/82; G06V 20/58

(57) ABSTRACT

An image processing apparatus includes an encoder and a decoder. The encoder includes a first convolution processor. The first convolution processor generates, based on first feature quantity data and first control data, second feature quantity data by performing a first convolution process on the first feature quantity data. The first feature quantity data includes captured image data and depth image data. The depth image data includes map data on a depth value of a subject corresponding to the captured image data. The first control data includes map data on validity of the depth value corresponding to the depth image data. The encoder generates pieces of feature quantity data including feature quantity data corresponding to the second feature quantity data. The decoder generates, based on the pieces of feature quantity data, an inference result of an environment around an imager that has generated the captured image data.

### CROSS-REFERENCE TO RELATED APPLICATION

The present application claims priority from Japanese Patent Application No. 2023-115066 filed on Jul. 13, 2023, the entire contents of which are hereby incorporated by reference.

### BACKGROUND

The disclosure relates to an image processing apparatus that performs a recognition process, based on a captured image.

Some image processing apparatuses perform a machine learning process, based on a captured image and a depth image. For example, Japanese Unexamined Patent Application Publication (Published Japanese Translation of PCT Application) No. JP2023-503827 discloses a technique that performs a machine learning process to generate a depth image, based on a captured image.

### SUMMARY

An aspect of the disclosure provides an image processing apparatus includes an encoder and a decoder. The encoder includes a first convolution processor. The first convolution processor is configured to generate, based on first feature quantity data and first control data, second feature quantity data by performing a first convolution process on the first feature quantity data. The first feature quantity data includes captured image data and depth image data. The depth image data includes map data on a depth value of a subject corresponding to the captured image data. The first control data includes map data on validity of the depth value corresponding to the depth image data. The encoder is configured to generate pieces of feature quantity data including feature quantity data corresponding to the second feature quantity data. The decoder is configured to generate, based on the pieces of feature quantity data, an inference result of an environment around an imager that has generated the captured image data.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is an explanatory diagram illustrating a configuration example of a surrounding environment recognition device according to one example embodiment of the disclosure.

FIG. 2 is a block diagram illustrating a configuration example of the surrounding environment recognition device illustrated in FIG. 1.

FIG. 3 is a block diagram illustrating a configuration example of a recognition processor illustrated in FIG. 2.

FIG. 4 is a block diagram illustrating a configuration example of a data processing device that generates a machine learning model to be used by the recognition processor illustrated in FIG. 3.

FIG. 5 is a block diagram illustrating a configuration example of a convolutional neural network in image processors illustrated in FIGS. 3 and 4.

FIG. 6 is a block diagram illustrating a configuration example of one of two encoders illustrated in FIG. 5.

FIG. 7 is a block diagram illustrating a configuration example of the other one of the two encoders illustrated in FIG. 5.

FIG. 8A is a block diagram illustrating a configuration example of convolution processors illustrated in FIG. 7.

FIG. 8B is a block diagram illustrating another configuration example of the convolution processors illustrated in FIG. 7.

FIG. 8C is a block diagram illustrating another configuration example of the convolution processors illustrated in FIG. 7.

FIG. 9 is a block diagram illustrating a configuration example of a decoder illustrated in FIG. 5.

FIG. 10 is an explanatory diagram illustrating an example of a captured image.

FIG. 11 is an explanatory diagram illustrating an example of map data in mask data.

FIG. 12 is an explanatory diagram illustrating an example of inference result data related to teaching data.

FIG. 13 is an explanatory diagram illustrating an example of inference result data generated by a machine learning model.

FIG. 14 is a block diagram illustrating a configuration example of a convolutional neural network according to a reference example.

FIG. 15 is a block diagram illustrating a configuration example of an encoder illustrated in FIG. 14.

FIG. 16 is an explanatory diagram illustrating an example of inference result data generated by a machine learning model according to the reference example.

FIG. 17 is a block diagram illustrating a configuration example of a convolutional neural network according to another reference example.

FIG. 18 is a block diagram illustrating a configuration example of an encoder illustrated in FIG. 17.

FIG. 19 is an explanatory diagram illustrating an example of inference result data generated by a machine learning model according to the other reference example.

FIG. 20 is a block diagram illustrating a configuration example of a convolutional neural network according to a modification example.

FIG. 21 is a block diagram illustrating a configuration example of an encoder illustrated in FIG. 20.

### DETAILED DESCRIPTION

Some image processing apparatuses recognize a surrounding environment of a camera that has generated a captured image. In such an image processing apparatus, it is desired that the surrounding environment be recognized with high recognition accuracy.

It is desirable to provide an image processing apparatus that makes it possible to improve recognition accuracy.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

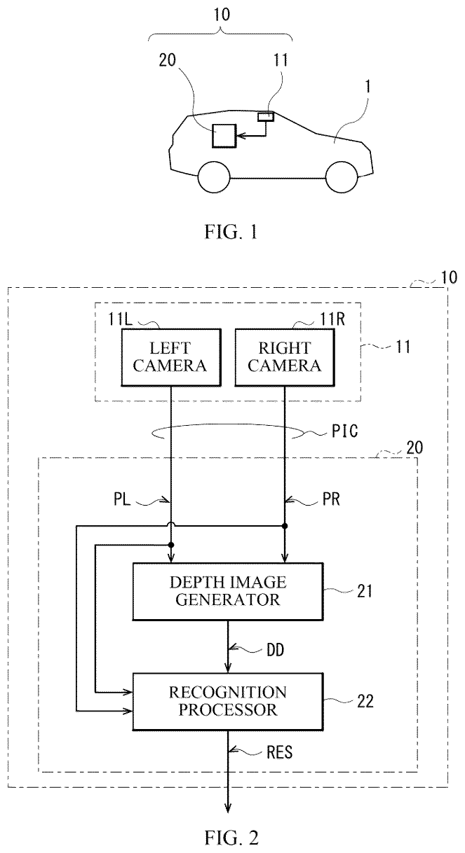

FIGS. 1 and 2 illustrate a configuration example of a surrounding environment recognition device 10 including an image processing apparatus according to an example embodiment. In this example, the surrounding environment recognition device 10 may be mounted on a vehicle 1. The vehicle 1 may be any vehicle such as an automobile. The surrounding environment recognition device 10 may be configured to recognize a surrounding environment of the vehicle 1. Here, the surrounding environment may include, for example, a mobile object, a stationary object, and a state related to traveling. The mobile object may include an object such as another vehicle, a bicycle, a pedestrian, or an animal around the vehicle 1, and the stationary object may include an object such as a building, a road sign, or a road marking around the vehicle 1. The state related to traveling may include a state such as a weather state or a wetting or freezing state of a road surface around the vehicle 1. The surrounding environment recognition device 10 may include a stereo camera 11 and an image recognition device 20.

The stereo camera 11 may be configured to generate a set of image data including left image data PL and right image data PR having a parallax between each other by capturing images ahead of the vehicle 1. The stereo camera 11 may include a left camera 11L and a right camera 11R. Each of the left camera 11L and the right camera 11R may include a lens and an image sensor. In this example, the left camera 11L and the right camera 11R may be disposed in the vehicle 1 in the vicinity of an upper part of a windshield of the vehicle 1 and spaced apart from each other by a predetermined distance in a width direction of the vehicle 1. The left camera 11L may generate the left image data PL, and the right camera 11R may generate the right image data PR. The left image data PL and the right image data PR may constitute stereo image data PIC. The stereo camera 11 may be configured to perform an imaging operation at a predetermined frame rate (for example, 60 [fps]) to generate a series of stereo image data PIC, and supply the generated stereo image data PIC to the image recognition device 20.

The image recognition device 20 may be configured to recognize the environment around the vehicle 1, based on the stereo image data PIC supplied from the stereo camera 11. In the vehicle 1, for example, based on data on an object recognized by the image recognition device 20, it is possible to, for example, cause a travel control of the vehicle 1 to be performed or information on the recognized object to be displayed on a console monitor. The image recognition device 20 may include, for example, a central processing unit (CPU) that executes a program, a random-access memory (RAM) that temporarily stores processing data, and a read-only memory (ROM) that stores the program. The image recognition device 20 may include a depth image generator 21 and a recognition processor 22.

The depth image generator 21 may be configured to generate depth image data DD by performing predetermined image processing including a stereo matching process, based on the left image data PL and the right image data PR. The depth image data DD may be map data on a depth of a subject. A pixel value of the depth image data DD may indicate a depth value. The depth value may be a distance from the stereo camera 11 to the subject in a three-dimensional real space.

The depth image generator 21 may obtain a parallax by performing the stereo matching process to detect corresponding points including image points in a left image related to the left image data PL and image points in a right image related to the right image data PR corresponding to each other, and calculate the depth, based on the parallax. In some cases, it may be difficult for the depth image generator 21 to obtain the depth in a certain image region due to, for example, occlusion. In this case, the depth image generator 21 may be configured to set the pixel value of that certain image region in the depth image data DD to a predetermined value indicating an error instead of the depth value.

The recognition processor 22 may be configured to generate a recognition result RES by recognizing the environment around the vehicle 1, based on the left image data PL and the right image data PR, and the depth image data DD generated by the depth image generator 21.

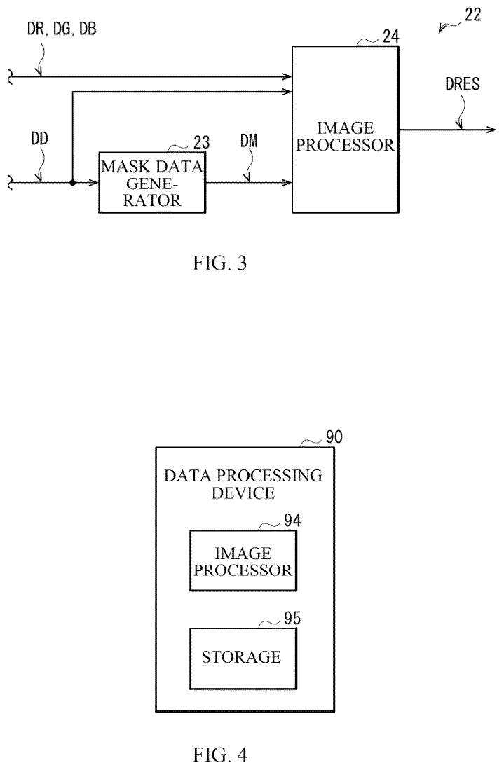

FIG. 3 illustrates a configuration example of the recognition processor 22. The recognition processor 22 may include a mask data generator 23 and an image processor 24. The recognition processor 22 may perform processing, based on red image data DR, green image data DG, and blue image data DB, which are included in one of the left image data PL or the right image data PR, and the depth image data DD.

The mask data generator 23 may be configured to generate mask data DM, based on the depth image data DD. The mask data DM may be tensor data including map data indicating validity of the depth value in the depth image data DD. As will be described later, the image processor 24 may perform processing based on the tensor data related to pieces of image data for four channels (the pieces of image data DR, DG, and DB and the depth image data DD). Accordingly, the mask data generator 23 may generate the tensor data including map data for four channels as the mask data DM. For example, the map data for four channels may be the same as each other. The pixel value of the map data in the mask data DM may be “1” or “0”. The value “1” may indicate that the pixel value of the depth image data DD at a given pixel position is the depth value, and “0” may indicate that the pixel value of the depth image data DD at a given pixel position is a predetermined value indicating an error. In other words, in the image region in which the pixel value of the map data is “0”, the depth value of the depth image data DD may be missing. The mask data generator 23 may be configured to generate the mask data DM including such map data, based on the depth image data DD.

For example, the image processor 24 may be configured to generate inference result data DRES indicating an inference result of the surrounding environment using a machine learning model, based on the pieces of image data DR, DG, and DB included in one of the left image data PL or the right image data PR, and the mask data DM. The inference result data DRES may be tensor data including map data corresponding to the image data. The machine learning model to be used in the image processor 24 may be a convolutional neural network (CNN) model. The recognition processor 22 may be configured to perform processing, based on the inference result data DRES, and generate the recognition result RES.

It is possible for the image processor 24 to perform various recognition processes using the convolutional neural network. For example, the image processor 24 may perform object detection by, for example, identifying a position of an object that is a subject in an image using a rectangle and classifying the object as to what kind of object the object is. Further, the image processor 24 may perform classification, for example, on a pixel-by-pixel basis. This may be referred to as semantic segmentation. Further, the image processor 24 may perform, for example, classification of instances in addition to classification on a pixel-by-pixel basis. This may be referred to as instance segmentation. Further, the image processor 24 may perform image classification by, for example, classifying the overall image.

FIG. 4 illustrates a configuration example of a data processing device 90 that generates the machine learning model to be used in the image processor 24. The data processing device 90 may be, for example, a personal computer, or any device having capability to generate a machine learning model. The data processing device 90 may include an image processor 94 and a storage 95.

The image processor 94 may include, for example, a CPU and a RAM, and may be configured to generate the machine learning model by performing a machine learning process using data sets supplied from the storage 95. Each of the data sets may include the pieces of image data DR, DG, and DB, the depth image data DD, the mask data DM, and teaching data.

The storage 95 may include, for example, a solid state drive (SSD) and a hard disk drive (HDD) and may be configured to store the data sets. The data sets may be prepared in advance by an engineer, for example, and stored in the storage 95. The data processing device 90 may be configured to generate the machine learning model by performing the machine learning process using the data sets.

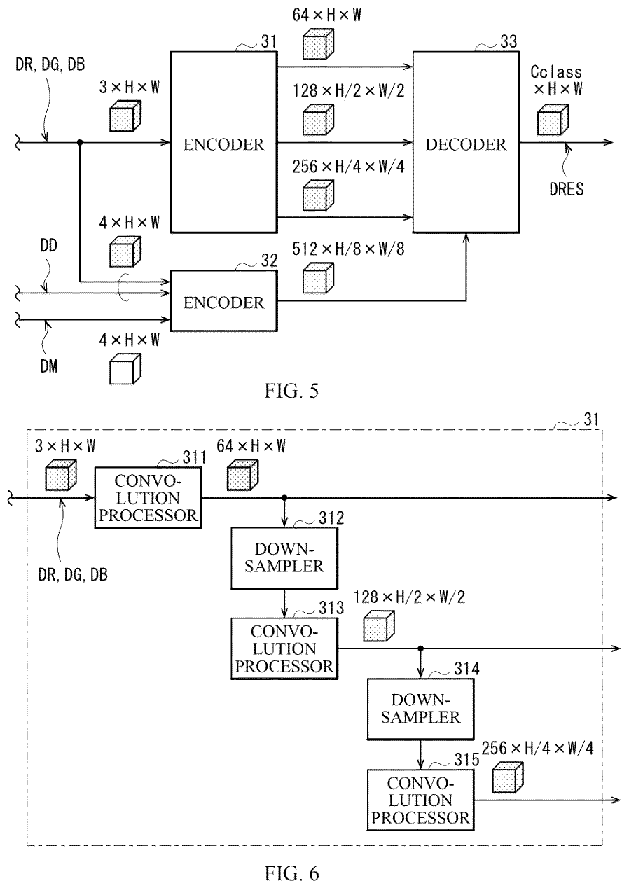

FIG. 5 illustrates an example of the convolutional neural network in the image processor 24 (FIG. 3) and the image processor 94 (FIG. 4). The convolutional neural network includes encoders 31 and 32 and a decoder 33. In this example, the convolutional neural network may have an architecture referred to as a U-Net architecture. The U-Net architecture is described, for example, in the following document: Ronneberger, Olaf, Philipp Fischer, and Thomas Brox. “U-Net: Convolutional networks for biomedical image segmentation.” International Conference on Medical image computing and computer-assisted intervention. Springer, Cham, 2015.

In this example, feature quantity data related to the pieces of image data DR, DG, and DB and the depth image data DD, and control data related to the mask data DM may be treated as three-dimensional tensor data. In FIG. 5, these pieces of data may be illustrated as cubes. In FIG. 5, the feature quantity data may be represented by a shaded cube, and the control data may be represented by an unshaded cube.

The encoder 31 may be configured to generate three pieces of feature quantity data, based on the feature quantity data related to the pieces of image data DR, DG, and DB. The size of the feature quantity data to be inputted to the encoder 31 may be “3×H×W”. Here, “3” may be the number of channels and may be the number of pieces of image data (the three pieces of image data DR, DG, and DB). “H” may indicate the number of pixels in a longitudinal direction of the image, and “W” may indicate the number of pixels in a lateral direction of the image. The three pieces of image data DR, DG, and DB may have image sizes that are the same as each other. The sizes of the three pieces of feature quantity data to be outputted by the encoder 31 may each be “64×H×W”, “128×H/2×W/2”, and “256×H/4×W/4”.

The encoder 32 is configured to generate feature quantity data, based on the feature quantity data related to the pieces of image data DR, DG, and DB and the depth image data DD, and the control data related to the mask data DM. The image size of the depth image data DD may be the same as the image size of each of the three pieces of image data DR, DG, and DB. The image size of the mask data DM may be the same as the image size of each of the three pieces of image data DR, DG, and DB. The size of the feature quantity data related to the pieces of image data DR, DG, and DB and the depth image data DD may be “4×H×W”. Here, “4” may be the number of pieces of image data (the three pieces of image data DR, DG, and DB and one piece of depth image data DD). The size of the control data related to the mask data DM may be the same as the size of the feature quantity data related to the pieces of image data DR, DG, and DB and the depth image data DD, and may be “4×H×W”. The size of the feature quantity data to be generated by the encoder 32 may be “512×H/8×W/8”.

Note that, in this example, the image sizes of the pieces of image data DR, DG, and DB, the depth image data DD, and the mask data DM may be the same as each other; however, the sizes may be partially different, for example. In this case, it is possible to match the image sizes by performing upsampling or downsampling as appropriate.

The decoder 33 may be configured to generate the inference result data DRES, based on the three pieces of feature quantity data supplied from the encoder 31 and one piece of feature quantity data supplied from the encoder 32. For example, in the case of the semantic segmentation, the size of the inference result data DRES may be “Cclass×H×W”. The “Cclass” may be the number of classes usable in classification. In other words, the inference result data DRES may include map data for each class used in the classification.

FIG. 6 illustrates a configuration example of the encoder 31. The encoder 31 may include a convolution processor 311, a downsampler 312, a convolution processor 313, a downsampler 314, and a convolution processor 315.

The convolution processor 311 may be configured to generate feature quantity data by performing a convolution process, based on the feature quantity data related to the pieces of image data DR, DG, and DB inputted to the encoder 31. The size of the feature quantity data to be inputted to the convolution processor 311 may be “3×H×W”, and the size of the feature quantity data to be outputted by the convolution processor 311 may be “64×H×W”.

The downsampler 312 may be configured to generate feature quantity data by performing a downsampling process, based on the feature quantity data supplied from the convolution processor 311. The size of the feature quantity data to be outputted by the downsampler 312 may be “64×H/2×W/2”. The convolution processor 313 may be configured to generate feature quantity data by performing the convolution process, based on the feature quantity data supplied from the downsampler 312. The size of the feature quantity data to be outputted by the convolution processor 313 may be “128×H/2×W/2”.

The downsampler 314 may be configured to generate feature quantity data by performing the downsampling process, based on the feature quantity data supplied from the convolution processor 313. The size of the feature quantity data to be outputted by the downsampler 314 may be “128×H/4×W/4”. The convolution processor 315 may be configured to generate feature quantity data by performing the convolution process, based on the feature quantity data supplied from the downsampler 314. The size of the feature quantity data to be outputted by the convolution processor 315 may be “256×H/4×W/4”.

With the configuration as described above, the encoder 31 may repeat the convolution process, based on the feature quantity data related to the pieces of image data DR, DG, and DB inputted to the encoder 31. As a result, the encoder 31 may compress image data related to the pieces of image data DR, DG, and DB step by step. The encoder 31 may be configured to output the three pieces of feature quantity data generated by the convolution processors 311, 313, and 315.

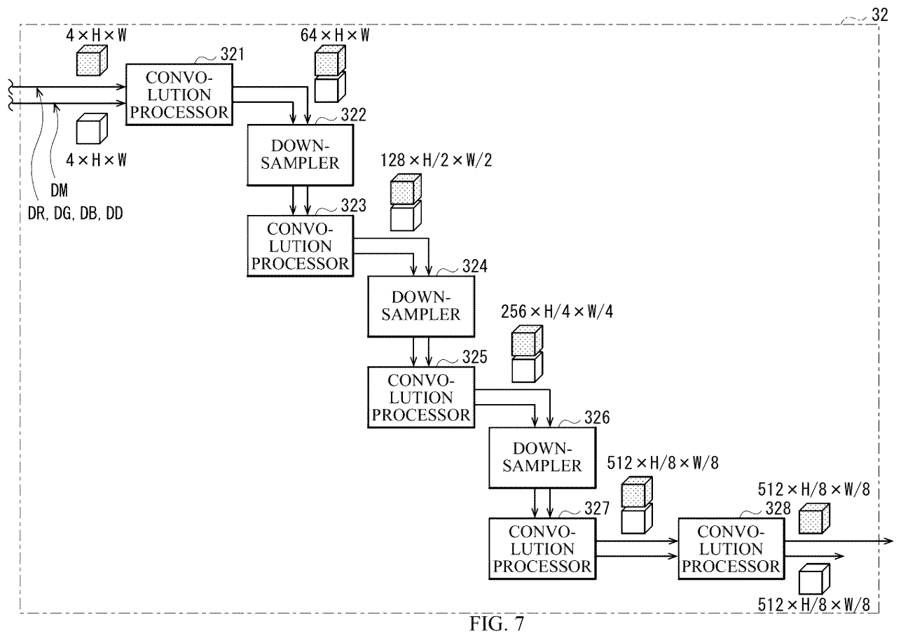

FIG. 7 illustrates a configuration example of the encoder 32. The encoder 32 may include a convolution processor 321, a downsampler 322, a convolution processor 323, a downsampler 324, a convolution processor 325, a downsampler 326, and convolution processors 327 and 328.

The convolution processor 321 may be configured to generate feature quantity data by performing the convolution process, based on the feature quantity data related to the pieces of image data DR, DG, and DB and the depth image data DD, and the control data related to the mask data DM, which are inputted to the encoder 32, and update the control data that has been inputted. For example, the convolution processor 321 may generate the feature quantity data by performing the convolution process on an image part of the feature quantity data related to the pieces of image data DR, DG, and DB and the depth image data DD where no depth value is missing, based on the control data related to the mask data DM. The sizes of the feature quantity data and the control data to be inputted to the convolution processor 321 may each be “4×H×W”, and the sizes of the feature quantity data and the control data to be outputted by the convolution processor 321 may each be “64×H×W”.

The downsampler 322 may be configured to generate feature quantity data and control data by performing the downsampling process, based on the feature quantity data and the control data supplied from the convolution processor 321. The sizes of the feature quantity data and the control data to be outputted by the downsampler 322 may each be “64×H/2×W/2”. The convolution processor 323 may be configured to generate feature quantity data by performing the convolution process, based on the feature quantity data and the control data supplied from the downsampler 322, and update the control data that has been inputted. The sizes of the feature quantity data and the control data to be outputted by the convolution processor 323 may each be “128×H/2×W/2”.

The downsampler 324 may be configured to generate feature quantity data and control data by performing the downsampling process, based on the feature quantity data and the control data supplied from the convolution processor 323. The sizes of the feature quantity data and the control data to be outputted by the downsampler 324 may each be “128×H/4×W/4”. The convolution processor 325 may be configured to generate feature quantity data by performing the convolution process, based on the feature quantity data and the control data supplied from the downsampler 324, and update the control data that has been inputted. The sizes of the feature quantity data and the control data to be outputted by the convolution processor 325 may each be “256×H/4×W/4”.

The downsampler 326 may be configured to generate feature quantity data and control data by performing the downsampling process, based on the feature quantity data and the control data supplied from the convolution processor 325. The sizes of the feature quantity data and the control data to be outputted by the downsampler 326 may each be “256×H/8×W/8”. The convolution processor 327 may be configured to generate feature quantity data by performing the convolution process, based on the feature quantity data and the control data supplied from the downsampler 326, and update the control data that has been inputted. The sizes of the feature quantity data and the control data to be outputted by the convolution processor 327 may each be “512×H/8×W/8”.

The convolution processor 328 may be configured to generate feature quantity data by performing the convolution process, based on the feature quantity data and the control data supplied from the convolution processor 327, and update the control data that has been inputted. The sizes of the feature quantity data and the control data to be outputted by the convolution processor 328 may each be “512×H/8×W/8”.

With the configuration as described above, the encoder 32 may repeat the convolution process, based on the feature quantity data related to the pieces of image data DR, DG, and DB and the depth image data DD, and the control data related to the mask data DM, which are inputted to the encoder 32. As a result, the encoder 32 may compress the image data related to the pieces of image data DR, DG, and DB and the depth image data DD step by step. At this time, the encoder 32 may perform processing on the image part where no depth value is missing, based on the mask data DM. This makes it possible to reduce an influence of the depth value being missing on the feature quantity data. The encoder 32 may be configured to output the feature quantity data out of the feature quantity data and the control data generated by the convolution processor 328.

Next, a configuration of the convolution processors 321, 323, 325, and 328 will be described with some examples.

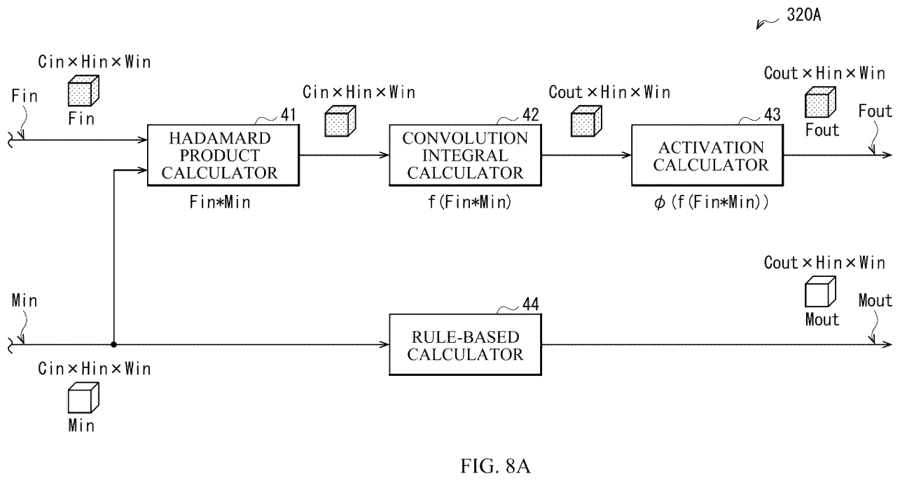

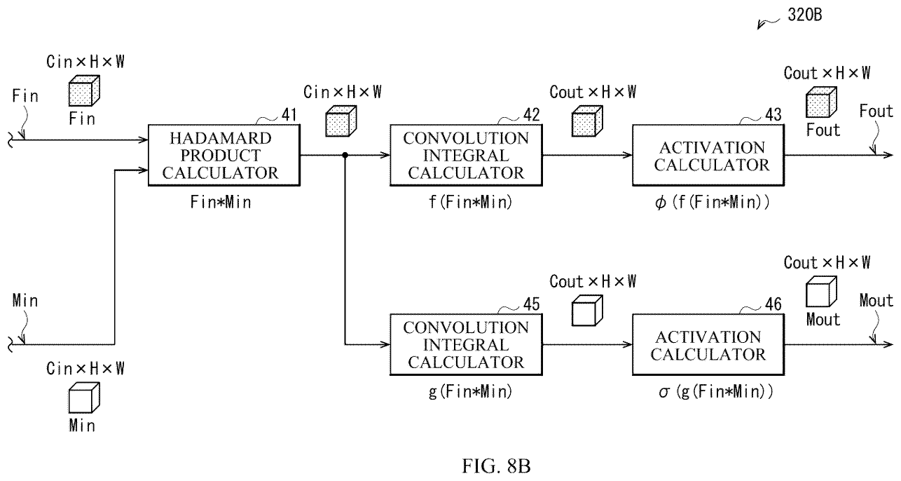

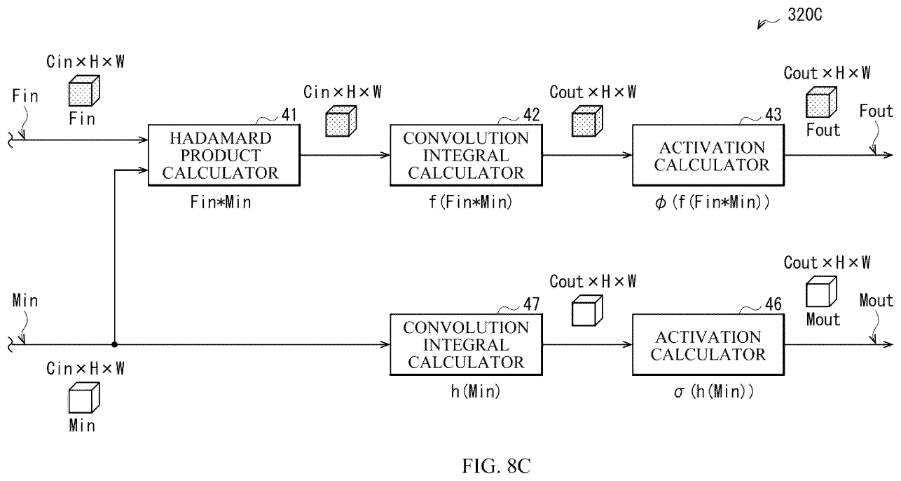

FIG. 8A illustrates a configuration example of a convolution processor 320A that is an example of the convolution processors 321, 323, 325, and 328. The convolution processor 320A may include an Hadamard product calculator 41, a convolution integral calculator 42, an activation calculator 43, and a rule-based calculator 44. The convolution processor 320A may generate feature quantity data Fout by performing the convolution process, based on feature quantity data Fin and control data Min, and generate control data Mout by updating the control data Min. The sizes of the feature quantity data Fin and the control data Min may each be “Cin×Hin×Win”. The sizes of the feature quantity data Fout and the control data Mout may each be “Cout×Hin×Win”. Here, “Cin” may be the number of channels of the feature quantity data Fin and the control data Min, “Hin” may be the number of pieces of data of the feature quantity data Fin and Fout and the control data Min and Mout in the longitudinal direction, “Win” may be the number of pieces of data of the feature quantity data Fin and Fout and the control data Min and Mout in the lateral direction, and “Cout” may be the number of channels of the feature quantity data Fout and the control data Mout. The number of channels Cout may be the same as or different from the number of channels Cin.

The Hadamard product calculator 41 may be configured to generate feature quantity data by calculating an Hadamard product of the feature quantity data Fin and the control data Min. For example, the Hadamard product calculator 41 may generate the feature quantity data by multiplying together a value in the feature quantity data Fin and a value in the control data Min at coordinate positions that are the same as each other. As a result, the convolution processor 320A may perform processing on the image part where no depth value is missing, based on the mask data DM. This makes it possible to reduce an influence of the depth value being missing on the feature quantity data. The size of the feature quantity data outputted by the Hadamard product calculator 41 may be “Cin×Hin×Win”, which is the same as the sizes of the feature quantity data Fin and the control data Min. In FIG. 8A, a result of the calculation performed by the Hadamard product calculator 41 may be indicated as “Fin*Min”.

The convolution integral calculator 42 may be configured to generate feature quantity data by performing convolution integration f, based on the feature quantity data supplied from the Hadamard product calculator 41. The size of the feature quantity data to be outputted by the convolution integral calculator 42 may be “Cout×Hin×Win”. In FIG. 8A, a result of the calculation performed by the convolution integral calculator 42 may be indicated as “f(Fin*Min)” using the convolution integration f. A calculation parameter of the convolution integration f may be adjusted by the data processing device 90 performing the machine learning process. The calculation parameter may include, for example, a weight parameter and a bias parameter.

The activation calculator 43 may be configured to generate the feature quantity data Fout by performing an activation calculation using an activation function φ, based on the feature quantity data supplied from the convolution integral calculator 42. In FIG. 8A, a result of the calculation performed by the activation calculator 43 may be indicated as “φ(f(Fin*Min))” using the activation function φ.

The rule-based calculator 44 may be configured to generate the control data Mout by performing a predetermined rule-based calculation, based on the control data Min. The rule-based calculator 44 may perform, for example, an expansion process that uses a morphological process.

When the convolution processor 320A is used, it is possible for the mask data generator 23 (FIG. 3) to generate the mask data DM by, for example, copying the map data generated based on the depth image data DD in a channel direction. For example, in this case, the pieces of map data for four channels in the mask data DM may be the same as each other.

In the convolution processor 320A, the calculation parameter of the convolution integration f related to the feature quantity data may be adjusted by the machine learning process. This makes it possible to improve the recognition accuracy of the recognition processor 22. Further, in the convolution processor 320A, the rule-based calculator 44 may perform calculation based on a rule designed by a human. This makes it possible for the convolution processor 320A to perform calculation that is easier for a human to interpret than when a calculation method obtained by the machine learning process is used.

FIG. 8B illustrates a configuration example of a convolution processor 320B that is another example of the convolution processors 321, 323, 325, and 328. The convolution processor 320B may include the Hadamard product calculator 41, the convolution integral calculator 42, the activation calculator 43, a convolution integral calculator 45, and an activation calculator 46. The Hadamard product calculator 41, the convolution integral calculator 42, and the activation calculator 43 may be similar to those of the convolution processor 320A (FIG. 8A).

The convolution integral calculator 45 may be configured to generate control data by performing a convolution integration g, based on the feature quantity data supplied from the Hadamard product calculator 41. The size of the control data to be outputted by the convolution integral calculator 45 may be “Cout×H×W”. In FIG. 8B, a result of the calculation performed by the convolution integral calculator 45 may be indicated as “g(Fin*Min)” using the convolution integration g. A calculation parameter of the convolution integration g may be adjusted by the data processing device 90 performing the machine learning process. The calculation parameter may include, for example, a weight parameter and a bias parameter.

The activation calculator 46 may be configured to generate the control data Mout by performing an activation calculation using an activation function σ, based on the control data supplied from the convolution integral calculator 45. The activation function σ may be a nonlinear function where an output value is 0 or higher and 1 or lower, and may be a sigmoid function, for example. In FIG. 8B, a result of the calculation performed by the activation calculator 46 may be indicated as “σ(g(Fin*Min))” using the activation function σ.

When the convolution processor 320B is used, it is possible for the mask data generator 23 (FIG. 3) to generate the mask data DM by, for example, copying the map data generated based on the depth image data DD in the channel direction. For example, in this case, the pieces of map data for four channels in the mask data DM may be the same as each other. Further, the mask data generator 23 may generate the mask data DM by, for example, generating map data corresponding to the depth image data DD out of the pieces of map data for four channels, based on the depth image data DD, and setting all the pixel values in the three pieces of map data corresponding to the pieces of image data DR, DG, and DB to “1”.

In the convolution processor 320B, in addition to the calculation parameter of the convolution integration f related to the feature quantity data, the calculation parameter of the convolution integration g related to the control data may also be adjusted by the machine learning process. Because the convolution integration g is adjusted to be an optimal calculation, it is possible to further improve the recognition accuracy of the recognition processor 22.

FIG. 8C illustrates a configuration example of a convolution processor 320C that is another example of the convolution processors 321, 323, 325, and 328. The convolution processor 320C may include the Hadamard product calculator 41, the convolution integral calculator 42, the activation calculator 43, a convolution integral calculator 47, and the activation calculator 46. The Hadamard product calculator 41, the convolution integral calculator 42, and the activation calculator 43 may be similar to those of the convolution processor 320A (FIG. 8A). The activation calculator 46 may be similar to that of the convolution processor 320B (FIG. 8B).

The convolution integral calculator 47 may be configured to generate control data by performing convolution integration h, based on the control data Min. The size of the control data to be outputted by the convolution integral calculator 47 may be “Cout×H×W”. In FIG. 8C, a result of the calculation performed by the convolution integral calculator 47 may be indicated as “h(Min)” using the convolution integration h. A calculation parameter of the convolution integration h may be adjusted by the data processing device 90 performing the machine learning process. The calculation parameter may include, for example, a weight parameter and a bias parameter.

When the convolution processor 320C is used, it is possible for the mask data generator 23 (FIG. 3) to generate the mask data DM by, for example, copying the map data generated based on the depth image data DD in the channel direction. For example, in this case, the pieces of map data for four channels in the mask data DM may be the same as each other. Further, the mask data generator 23 may generate the mask data DM by, for example, generating map data corresponding to the depth image data DD out of the pieces of map data for four channels, based on the depth image data DD, and setting all the pixel values in the three pieces of map data corresponding to the pieces of image data DR, DG, and DB to “1”.

In the convolution processor 320C, in addition to the calculation parameter of the convolution integration f related to the feature quantity data, the calculation parameter of the convolution integration h related to the control data may also be adjusted by the machine learning process. Because the convolution integration h is adjusted to be an optimal calculation, it is possible to further improve the recognition accuracy of the recognition processor 22. Further, the convolution processor 320C may use no feature quantity data Fin in the calculation to generate the control data Mout. Accordingly, in the convolution processor 320C, it is possible to further improve the recognition accuracy of the recognition processor 22 because the convolution integration h is adjusted to be an optimal calculation without being affected by the feature quantity data Fin.

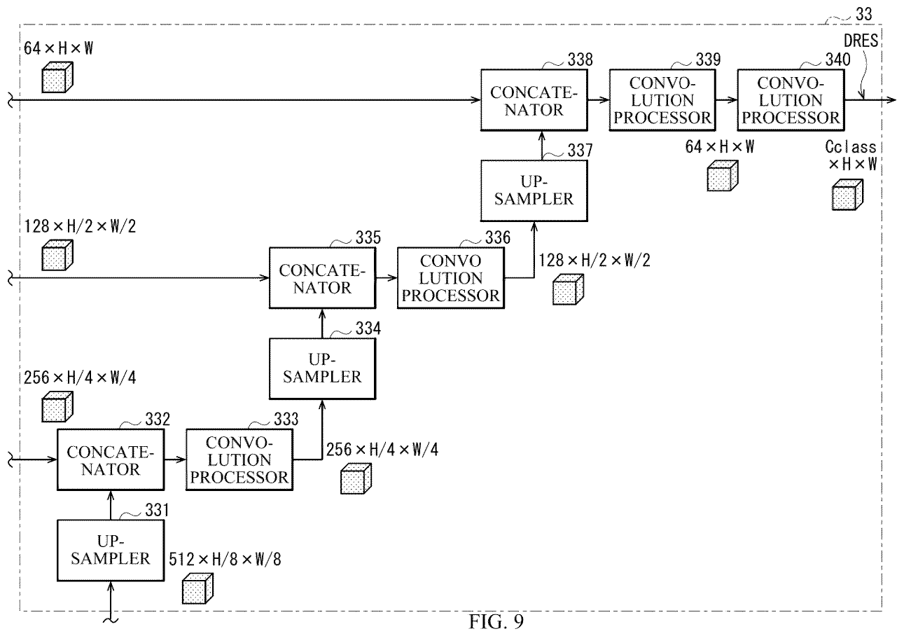

FIG. 9 illustrates a configuration example of the decoder 33 illustrated in FIG. 5. The decoder 33 may include an upsampler 331, a concatenator 332, a convolution processor 333, an upsampler 334, a concatenator 335, a convolution processor 336, an upsampler 337, a concatenator 338, and convolution processors 339 and 340.

The upsampler 331 may be configured to generate feature quantity data by performing an upsampling process, based on the feature quantity data supplied from the encoder 32. The size of the feature quantity data supplied from the encoder 32 may be “512×H/8×W/8”. The size of the feature quantity data to be outputted by the upsampler 331 may be “512×H/4×W/4”. The concatenator 332 may be configured to concatenate the feature quantity data supplied from the encoder 31 and the feature quantity data supplied from the upsampler 331 in the channel direction. The size of the feature quantity data supplied from the encoder 31 may be “256×H/4×W/4”. The size of the feature quantity data to be outputted by the concatenator 332 may be “768×H/4×W/4”. The convolution processor 333 may be configured to generate feature quantity data by performing the convolution process, based on the feature quantity data supplied from the concatenator 332. The size of the feature quantity data to be outputted by the convolution processor 333 may be “256×H/4×W/4”.

The upsampler 334 may be configured to generate feature quantity data by performing the upsampling process, based on the feature quantity data supplied from the convolution processor 333. The size of the feature quantity data to be outputted by the upsampler 334 may be “256×H/2×W/2”. The concatenator 335 may be configured to concatenate the feature quantity data supplied from the encoder 31 and the feature quantity data supplied from the upsampler 334 in the channel direction. The size of the feature quantity data supplied from the encoder 31 may be “128×H/2×W/2”. The size of the feature quantity data to be outputted by the concatenator 335 may be “384×H/2×W/2”. The convolution processor 336 may be configured to generate feature quantity data by performing the convolution process, based on the feature quantity data supplied from the concatenator 335. The size of the feature quantity data to be outputted by the convolution processor 336 may be “128×H/2×W/2”.

The upsampler 337 may be configured to generate feature quantity data by performing the upsampling process, based on the feature quantity data supplied from the convolution processor 336. The size of the feature quantity data to be outputted by the upsampler 337 may be “128×H×W”. The concatenator 338 may be configured to concatenate the feature quantity data supplied from the encoder 31 and the feature quantity data supplied from the upsampler 337 in the channel direction. The size of the feature quantity data supplied from the encoder 31 may be “64×H×W”. The size of the feature quantity data to be outputted by the concatenator 338 may be “192×H×W”. The convolution processor 339 may be configured to generate feature quantity data by performing the convolution process, based on the feature quantity data supplied from the concatenator 338. The size of the feature quantity data to be outputted by the convolution processor 339 may be “64×H×W”.

The convolution processor 340 may be configured to generate the inference result data DRES by performing the convolution process, based on the feature quantity data supplied from the convolution processor 339. For example, in the case of the semantic segmentation, the size of the feature quantity data to be outputted by the convolution processor 340 may be “Cclass×H×W”. The “Cclass” may be the number of classes usable in classification.

With the configuration as described above, the decoder 33 may repeat the convolution process, based on the four pieces of feature quantity data supplied from the encoders 31 and 32. As a result, the size of the compressed image may return to an original size step by step. The decoder 33 may be configured to generate the inference result data DRES corresponding to applications such as object detection, semantic segmentation, instance segmentation, and image classification.

With this configuration, the data processing device 90 may generate the machine learning model, and the surrounding environment recognition device 10 may recognize the surrounding environment of the vehicle 1 using the machine learning model, based on the pieces of image data DR, DG, and DB, the depth image data DD, and the mask data DM. As described above, in the data processing device 90 and the surrounding environment recognition device 10, the mask data DM including the map data indicating the validity of the depth value in the depth image data DD may be inputted to the machine learning model. This makes it possible to improve the recognition accuracy.

In one embodiment, the image processors 24 and 94 may serve as an “image processing apparatus”. In one embodiment, the pieces of image data DR, DG, and DB may serve as “captured image data”. In one embodiment, the depth image data DD may serve as “depth image data”. In one embodiment, the pieces of image data DR, DG, and DB and the depth image data DD may serve as “first feature quantity data”. In one embodiment, the mask data DM may serve as “first control data”. In one embodiment, the convolution integration f may serve as a “first convolution process”. In one embodiment, the convolution processor 321 may serve as a “first convolution processor”. In one embodiment, the encoders 31 and 32 may serve as an “encoder”. In one embodiment, the decoder 33 may serve as a “decoder”. In one embodiment, the convolution processor 311 may serve as a “second convolution processor”. In one embodiment, the convolution integration g may serve as a “third convolution process”. In one embodiment, the convolution integration h may serve as a “fourth convolution process”. In one embodiment, the inference result data DRES may serve as an “inference result”. In one embodiment, the stereo camera 11 may serve as an “imager”. In one embodiment, the pieces of image data DR, DG, and DB may serve as “third feature quantity data”.

Next, operations and workings of the data processing device 90 and the surrounding environment recognition device 10 according to the example embodiment will now be described.

First, with reference to FIGS. 1 to 4, an overview of an overall operation of the surrounding environment recognition device 10 and the data processing device 90 will be described.

The image processor 94 of the data processing device 90 may generate the machine learning model by performing the machine learning process using the data sets including the pieces of image data DR, DG, and DB, the depth image data DD, the mask data DM, and the teaching data, which are supplied from the storage 95.

The stereo camera 11 may generate a set of image data including the left image data PL and the right image data PR having a parallax between each other by capturing images ahead of the vehicle 1. The depth image generator 21 of the image recognition device 20 may generate the depth image data DD by performing the predetermined image processing including the stereo matching process, based on the left image data PL and the right image data PR. The recognition processor 22 may recognize the environment around the vehicle 1, based on the left image data PL and the right image data PR, and the depth image data DD generated by the depth image generator 21. For example, the image processor 24 of the recognition processor 22 may generate the inference result data DRES indicating the inference result of the surrounding environment using the machine learning model, based on the pieces of image data DR, DG, and DB included in one of the left image data PL or the right image data PR, and the mask data DM.

In the convolutional neural network in the image processor 24 and the image processor 94, the encoder 31 may generate three pieces of feature quantity data, based on the feature quantity data related to the pieces of image data DR, DG, and DB as illustrated in FIG. 5. The encoder 32 may generate one piece of feature quantity data, based on the feature quantity data related to the pieces of image data DR, DG, and DB and the depth image data DD, and the control data related to the mask data DM. The decoder 33 may generate the inference result data DRES, based on the three pieces of feature quantity data supplied from the encoder 31 and the one piece of feature quantity data supplied from the encoder 32.

An example of the machine learning process that uses the convolutional neural network illustrated in FIG. 5 will be described below. In this example, the semantic segmentation may be performed in which classification is performed on a pixel-by-pixel basis. In this example, the convolution processors 321, 323, 325, and 328 illustrated in FIG. 7 may include the convolution processor 320C (FIG. 8C).

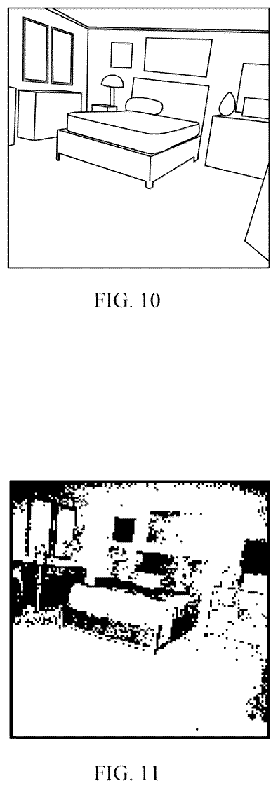

FIG. 10 illustrates an example of captured image data. FIG. 11 illustrates an example of the map data included in the mask data DM. The map data may correspond to the captured image illustrated in FIG. 10. A white image part in the map data illustrated in FIG. 10 may indicate that the pixel value of the depth image data DD is the depth value, and a black image part in the map data illustrated in FIG. 10 may indicate that the pixel value of the depth image data DD is not the depth value.

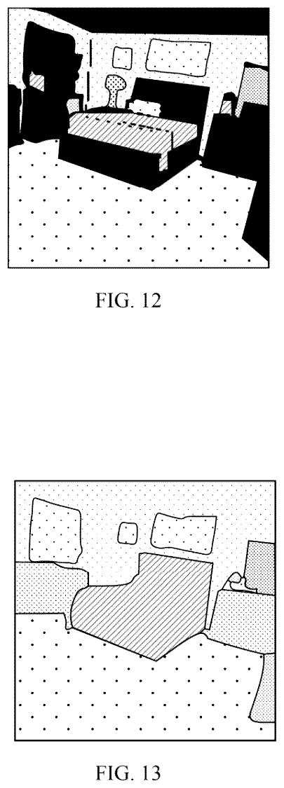

FIG. 12 illustrates an example of the teaching data. In the teaching data, classes may be assigned in accordance with subjects. For example, a floor class may be assigned to a floor, a bed class may be assigned to a mattress of a bed, a wall class may be assigned to a wall, and an art class may be assigned to a painting or a photograph placed on a wall. Note that, in this example, an unclassified class may be assigned to a part that is illustrated in black in FIG. 12 and not to be classified.

In this example of the machine learning process, the machine learning model was generated by performing the machine learning process using the data sets including the data as described above. The inference result data DRES was generated based on another captured image data using the generated machine learning model.

FIG. 13 illustrates an example of the inference result data DRES. In this example, it was verified that the shapes of subjects such as the floor, the bed, the wall, the painting, and the photograph were correctly recognized, and the classification of these subjects was correctly performed.

Next, a machine learning process that uses a convolutional neural network according to a reference example will be described in detail with some examples.

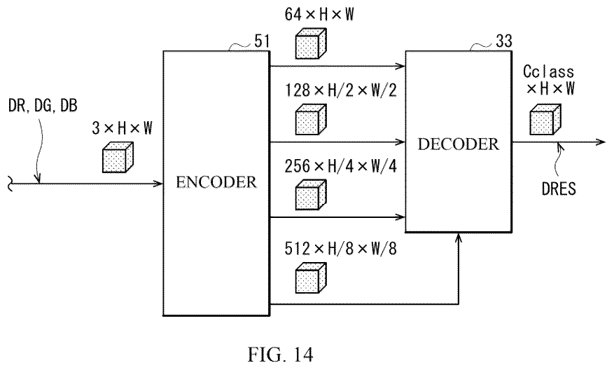

FIG. 14 illustrates an example of a convolutional neural network according to a reference example E1. The convolutional neural network may include an encoder 51 and the decoder 33. The convolutional neural network according to the reference example E1 may include the U-Net configuration as in the convolutional neural network according to the example embodiment (FIG. 5). The decoder 33 may be the same as the decoder 33 (FIGS. 5 and 9) according to the example embodiment.

The encoder 51 may be configured to generate four pieces of feature quantity data, based on the feature quantity data related to the pieces of image data DR, DG, and DB. In other words, in the example embodiment, as illustrated in FIG. 5, the encoder 31 may generate three pieces of feature quantity data, based on the feature quantity data related to the pieces of image data DR, DG, and DB, and the encoder 32 may generate one piece of feature quantity data, based on the feature quantity data related to the pieces of image data DR, DG, and DB and the depth image data DD, and the control data related to the mask data DM; however, in the reference example E1, the encoder 51 may generate four pieces of feature quantity data, based on the feature quantity data related to the pieces of image data DR, DG, and DB. The size of the feature quantity data to be inputted to the encoder 51 may be “3×H×W”. Here, “3” may be the number of channels and may be the number of pieces of image data (the three pieces of image data DR, DG, and DB). The sizes of the four pieces of feature quantity data to be outputted by the encoder 51 may each be “64×H×W”, “128×H/2×W/2”, “256×H/4×W/4”, and “512×H/8×W/8”.

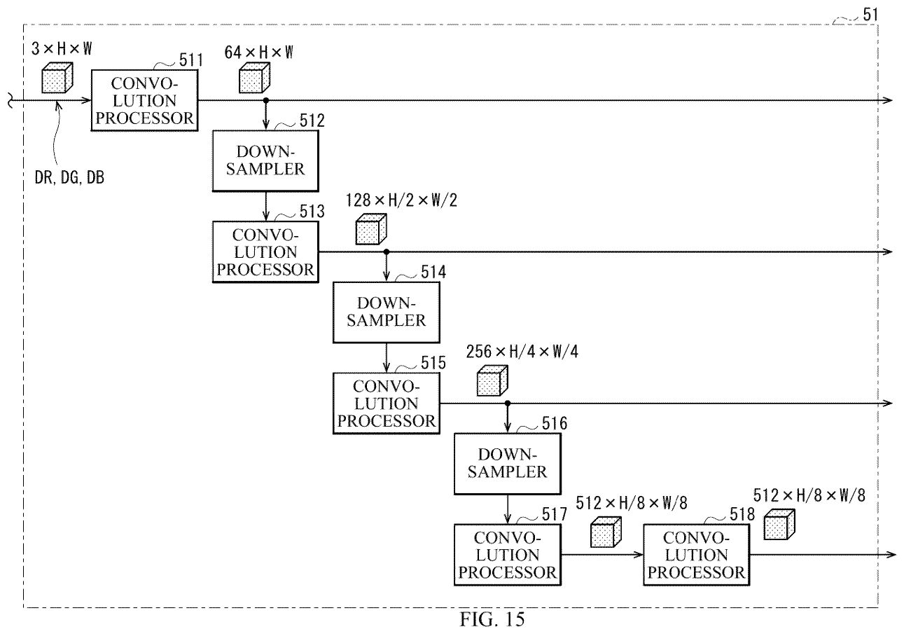

FIG. 15 illustrates a configuration example of the encoder 51. The encoder 51 may include a convolution processor 511, a downsampler 512, a convolution processor 513, a downsampler 514, a convolution processor 515, a downsampler 516, and convolution processors 517 and 518.

The convolution processor 511 may be configured to generate feature quantity data by performing the convolution process, based on the feature quantity data related to the pieces of image data DR, DG, and DB inputted to the encoder 51. The size of the feature quantity data to be inputted to the convolution processor 511 may be “3×H×W”, and the size of the feature quantity data to be outputted by the convolution processor 511 may be “64×H×W”.

The downsampler 512 may be configured to generate feature quantity data by performing the downsampling process, based on the feature quantity data supplied from the convolution processor 511. The size of the feature quantity data to be outputted by the downsampler 512 may be “64×H/2×W/2”. The convolution processor 513 may be configured to generate feature quantity data by performing the convolution process, based on the feature quantity data supplied from the downsampler 512. The size of the feature quantity data to be outputted by the convolution processor 513 may be “128×H/2×W/2”.

The downsampler 514 may be configured to generate feature quantity data by performing the downsampling process, based on the feature quantity data supplied from the convolution processor 513. The size of the feature quantity data to be outputted by the downsampler 514 may be “128×H/4×W/4”. The convolution processor 515 may be configured to generate feature quantity data by performing the convolution process, based on the feature quantity data supplied from the downsampler 514. The size of the feature quantity data to be outputted by the convolution processor 515 may be “256×H/4×W/4”.

The downsampler 516 may be configured to generate feature quantity data by performing the downsampling process, based on the feature quantity data supplied from the convolution processor 515. The size of the feature quantity data to be outputted by the downsampler 516 may be “256×H/8×W/8”. The convolution processor 517 may be configured to generate feature quantity data by performing the convolution process, based on the feature quantity data supplied from the downsampler 516. The size of the feature quantity data to be outputted by the convolution processor 517 may be “512×H/8×W/8”.

The convolution processor 518 may be configured to generate feature quantity data by performing the convolution process, based on the feature quantity data supplied from the convolution processor 517. The size of the feature quantity data to be outputted by the convolution processor 518 may be “512×H/8×W/8”.

With the configuration as described above, the encoder 51 may repeat the convolution process, based on the feature quantity data related to the pieces of image data DR, DG, and DB inputted to the encoder 51. The encoder 51 may be configured to output the four pieces of feature quantity data generated by the convolution processors 511, 513, 515, and 518.

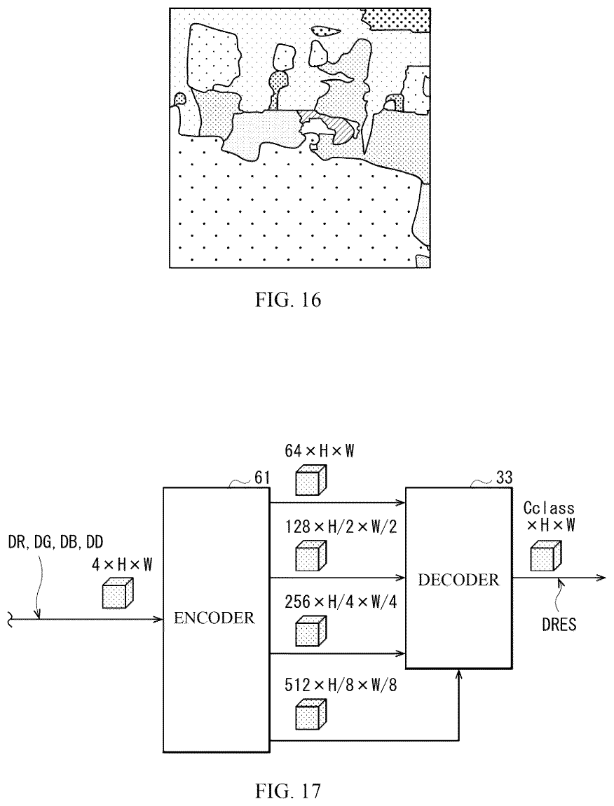

FIG. 16 illustrates an example of the inference result data DRES when the convolutional neural network according to the reference example E1 is used. In this example, the shapes of the subjects such as the bed, the picture, and the photograph may be incorrectly recognized. As described above, in the recognition process that simply uses the pieces of image data DR, DG, and DB, the recognition accuracy is lowered.

FIG. 17 illustrates an example of a convolutional neural network according to a reference example E2. The convolutional neural network may include an encoder 61 and the decoder 33. The convolutional neural network according to the reference example E2 may include the U-Net configuration as in the convolutional neural network according to the example embodiment (FIG. 5). The decoder 33 may be the same as the decoder 33 (FIGS. 5 and 9) according to the example embodiment.

The encoder 61 may be configured to generate four pieces of feature quantity data, based on the feature quantity data related to the pieces of image data DR, DG, and DB and the depth image data DD. In other words, in the example embodiment, as illustrated in FIG. 5, the encoder 31 may generate three pieces of feature quantity data, based on the feature quantity data related to the pieces of image data DR, DG, and DB, and the encoder 32 may generate one piece of feature quantity data, based on the feature quantity data related to the pieces of image data DR, DG, and DB and the depth image data DD, and the control data related to the mask data DM; however, in the reference example E2, the encoder 61 may generate four pieces of feature quantity data, based on the feature quantity data related to the pieces of image data DR, DG, and DB and the depth image data DD. The size of the feature quantity data to be inputted to the encoder 61 may be “4×H×W”. Here, “4” may be the number of channels and may be the number of pieces of image data (the three pieces of image data DR, DG, and DB and one piece of depth image data DD). The sizes of the four pieces of feature quantity data to be outputted by the encoder 61 may each be “64×H×W”, “128×H/2×W/2”, “256×H/4×W/4”, and “512×H/8×W/8”.

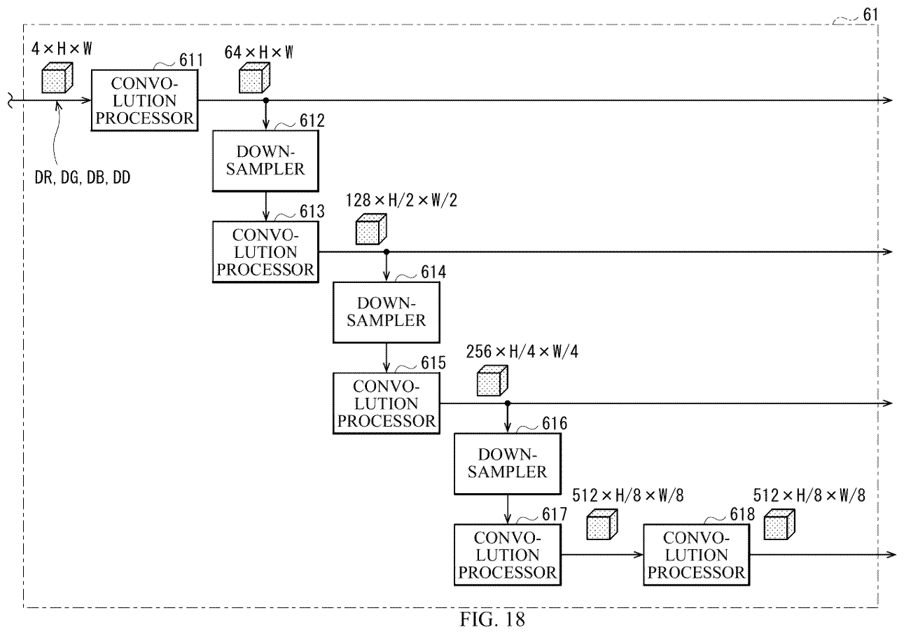

FIG. 18 illustrates a configuration example of the encoder 61. The encoder 61 may include a convolution processor 611, a downsampler 612, a convolution processor 613, a downsampler 614, a convolution processor 615, a downsampler 616, and convolution processors 617 and 618.

The convolution processor 611 may be configured to generate feature quantity data by performing the convolution process, based on the feature quantity data related to the pieces of image data DR, DG, and DB and the depth image data DD inputted to the encoder 61. The size of the feature quantity data to be inputted to the convolution processor 611 may be “4×H×W”, and the size of the feature quantity data to be outputted by the convolution processor 611 may be “64×H×W”.

The downsampler 612 may be configured to generate feature quantity data by performing the downsampling process, based on the feature quantity data supplied from the convolution processor 611. The size of the feature quantity data to be outputted by the downsampler 612 may be “64×H/2×W/2”. The convolution processor 613 may be configured to generate feature quantity data by performing the convolution process, based on the feature quantity data supplied from the downsampler 612. The size of the feature quantity data to be outputted by the convolution processor 613 may be “128×H/2×W/2”.

The downsampler 614 may be configured to generate feature quantity data by performing the downsampling process, based on the feature quantity data supplied from the convolution processor 613. The size of the feature quantity data to be outputted by the downsampler 614 may be “128×H/4×W/4”. The convolution processor 615 may be configured to generate feature quantity data by performing the convolution process, based on the feature quantity data supplied from the downsampler 614. The size of the feature quantity data to be outputted by the convolution processor 615 may be “256×H/4×W/4”.

The downsampler 616 may be configured to generate feature quantity data by performing the downsampling process, based on the feature quantity data supplied from the convolution processor 615. The size of the feature quantity data to be outputted by the downsampler 616 may be “256×H/8×W/8”. The convolution processor 617 may be configured to generate feature quantity data by performing the convolution process, based on the feature quantity data supplied from the downsampler 616. The size of the feature quantity data to be outputted by the convolution processor 617 may be “512×H/8×W/8”.

The convolution processor 618 may be configured to generate feature quantity data by performing the convolution process, based on the feature quantity data supplied from the convolution processor 617. The size of the feature quantity data to be outputted by the convolution processor 618 may be “512×H/8×W/8”.

With the configuration as described above, the encoder 61 may repeat the convolution process, based on the feature quantity data related to the pieces of image data DR, DG, and DB and the depth image data DD inputted to the encoder 61. The encoder 61 may be configured to output the four pieces of feature quantity data generated by the convolution processors 611, 613, 615, and 618.

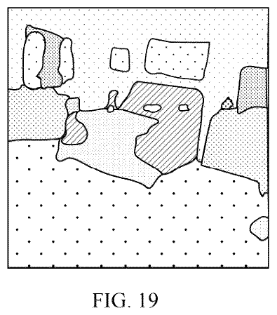

FIG. 19 illustrates an example of the inference result data DRES when the convolutional neural network according to the reference example E2 is used. In this example, the shapes of the bed, the picture, and the photograph may be correctly recognized compared with the inference result data DRES according to the reference example E1 (FIG. 16). However, for example, a part of the bed may be classified into a class different from the bed class, and a part of the painting or the photograph may be classified into a class different from the art class. As described above, the recognition process that uses the pieces of image data DR, DG, and DB and the depth image data DD makes it possible to improve the recognition accuracy compared with the case where simply the pieces of image data DR, DG, and DB are used (FIG. 16). However, the recognition accuracy may still be insufficient.

As described above, in the convolutional neural network according to the reference examples E1 and E2, the recognition accuracy may be insufficient as illustrated in FIGS. 16 and 19. For example, a DICE score in the reference example E1 (FIG. 16) was 0.62, and a DICE score in the reference example E2 (FIG. 19) was 0.654. The DICE score may be an index indicating the recognition accuracy, and the higher the value of the DICE score, the higher the recognition accuracy.

In the convolutional neural network according to the example embodiment, as illustrated in FIG. 13, the shapes of the bed, the picture, and the photograph may be correctly recognized, and the bed, the picture, and the photograph may be classified into the correct classes. The DICE score in the example embodiment (FIG. 13) was 0.668. As described above, in the convolutional neural network according to the example embodiment, the recognition process may be performed using the pieces of image data DR, DG, and DB, the depth image data DD, and the mask data DM. This makes it possible to reduce the influence of the depth value being missing on the feature quantity data, and improve the recognition accuracy.

As described above, the convolutional neural network of the image processor 24 or 94 includes encoder 31 or 32 and a decoder 33. The encoder 31 or 32 includes a first convolution processor (the convolution processor 321). The first convolution processor (the convolution processor 321) is configured to generate, based on first feature quantity data and first control data (the mask data DM), second feature quantity data by performing a first convolution process on the first feature quantity data. The first feature quantity data includes captured image data (the pieces of image data DR, DG, and DB) and depth image data DD including map data on a depth value of a subject corresponding to the captured image data (the pieces of image data DR, DG, and DB). The first control data (the mask data DM) includes map data on validity of the depth value corresponding to the depth image data DD. The encoder 31 or 32 is configured to generate pieces of feature quantity data including feature quantity data corresponding to the second feature quantity data. The decoder is configured to generate, based on the pieces of feature quantity data, an inference result of an environment around an imager that has generated the captured image data (the pieces of image data DR, DG, and DB). As a result, the first convolution processor may, for example, perform processing on the image part where no depth value is missing, based on the mask data DM. This makes it possible to reduce an influence of the depth value being missing on the second feature quantity data. As a result, it is possible for the convolutional neural network to improve the recognition accuracy.

In some embodiments, in the convolutional neural network of the image processor 24 or 94, the encoder 31 or 32 may further include a second convolution processor (the convolution processor 311) configured to generate, based on third feature quantity data including the captured image data (the pieces of image data DR, DG, and DB), fourth feature quantity data by performing a second convolution process on the third feature quantity data. The pieces of feature quantity data may include feature quantity data corresponding to the fourth feature quantity data. As a result, because it is possible to perform processing also on an image part where the depth value is missing, it is possible to obtain data to be processed when the image part where the depth value is missing is large, for example. As a result, it is possible for the convolutional neural network to improve the recognition accuracy.

In some embodiments, in the convolutional neural network of the image processor 24 or 94, the first convolution processor (the convolution processor 321) may be configured to generate multiplication data by multiplying a value in the first feature quantity data (the pieces of image data DR, DG, and DB and the depth image data DD) and a value in the first control data (the mask data DM) at coordinate positions corresponding to each other, and generate the second feature quantity data by performing the first convolution process, based on the multiplication data. As a result, because the first convolution processor may perform processing on the image part where no depth value is missing, based on the mask data DM, it is possible to reduce the influence of the depth value being missing on the second feature quantity data. As a result, it is possible for the convolutional neural network to improve the recognition accuracy.

As described above, in the example embodiment, an image processing apparatus includes an encoder and a decoder. The encoder includes a first convolution processor. The first convolution processor is configured to generate, based on first feature quantity data and first control data, second feature quantity data by performing a first convolution process on the first feature quantity data. The first feature quantity data includes captured image data and depth image data including map data on a depth value of a subject corresponding to the captured image data. The first control data includes map data on validity of the depth value corresponding to the depth image data. The encoder is configured to generate pieces of feature quantity data including feature quantity data corresponding to the second feature quantity data. The decoder is configured to generate, based on the pieces of feature quantity data, an inference result of an environment around an imager that has generated the captured image data. This helps to improve the recognition accuracy.

In some embodiments, the encoder may further include a second convolution processor configured to generate, based on third feature quantity data including the captured image data, fourth feature quantity data by performing a second convolution process on the third feature quantity data. The pieces of feature quantity data may include feature quantity data corresponding to the fourth feature quantity data. This helps to improve the recognition accuracy.

In some embodiments, the first convolution processor may be configured to generate multiplication data by multiplying a value in the first feature quantity data and a value in the first control data at coordinate positions corresponding to each other, and generate the second feature quantity data by performing the first convolution process, based on the multiplication data. This helps to improve the recognition accuracy.

In the above-described example embodiment, the convolution processor 320A, 320B, or 320C (FIG. 8A, 8B, or 8C) may be configured to perform the convolution integration and the activation calculation; however, this example is a non-limiting example, and another calculation may further be performed. In some embodiments, the convolution processor 320A, 320B, or 320C may be configured to perform an upsampling process of increasing resolution of the feature quantity using, for example, bilinear interpolation or nearest neighbor. In some embodiments, the convolution processor 320A, 320B, or 320C may be configured to perform a downsampling process of lowering the resolution of the feature quantity using, for example, max pooling or average pooling. In some embodiments, the convolution processor 320A, 320B, or 320C may be configured to perform a normalization process using, for example, batch normalization or instance normalization. In some embodiments, the convolution processor 320A, 320B, or 320C may be configured to perform a downsampling process by devising a convolution integration method such as setting a stride to 2 or higher or using pixel unshuffle. In some embodiments, the convolution processor 320A, 320B, or 320C may perform an upsampling process by devising a convolution integration method such as using a transposed convolution or pixel shuffle. In the convolution processors 320A to 320C illustrated in FIGS. 8A to 8C, the resolution (Hin, Win) of the feature quantity data and the control data to be inputted and the resolution (Hin, Win) of the feature quantity data and the control data to be outputted may be the same as each other. In some embodiments, when the upsampling process or the downsampling process as described above is performed, the resolution of the feature quantity data and the control data to be inputted and the resolution of the feature quantity data and the control data to be outputted may be different from each other.

In the above-described example embodiment, the encoder 31 may generate three pieces of feature quantity data, based on the feature quantity data related to the pieces of image data DR, DG, and DB, and the encoder 32 may generate one piece of feature quantity data, based on the feature quantity data related to the pieces of image data DR, DG, and DB and the depth image data DD, and the control data related to the mask data DM; however, this example is a non-limiting example. Hereinafter, the convolutional neural network according to a modification example 2 will be described in detail.

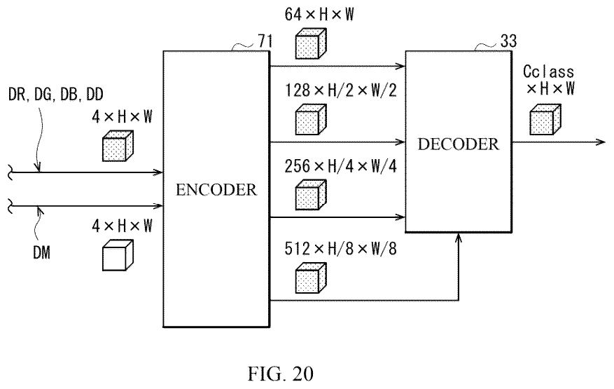

FIG. 20 illustrates an example of the convolutional neural network according to the modification example 2. The convolutional neural network may include an encoder 71 and the decoder 33. The convolutional neural network according to the modification example 2 may include the U-Net configuration as in the convolutional neural network according to the above-described example embodiment (FIG. 5). The decoder 33 may be the same as the decoder 33 (FIGS. 5 and 9) according to the example embodiment.

The encoder 71 may be configured to generate four pieces of feature quantity data, based on the feature quantity data related to the pieces of image data DR, DG, and DB and the depth image data DD, and the control data related to the mask data DM. The sizes of the feature quantity data and the control data to be inputted to the encoder 71 may each be “4×H×W”. The sizes of the four pieces of feature quantity data to be outputted by the encoder 71 may each be “64×H×W”, “128×H/2×W/2”, “256×H/4×W/4”, and “512×H/8×W/8”.

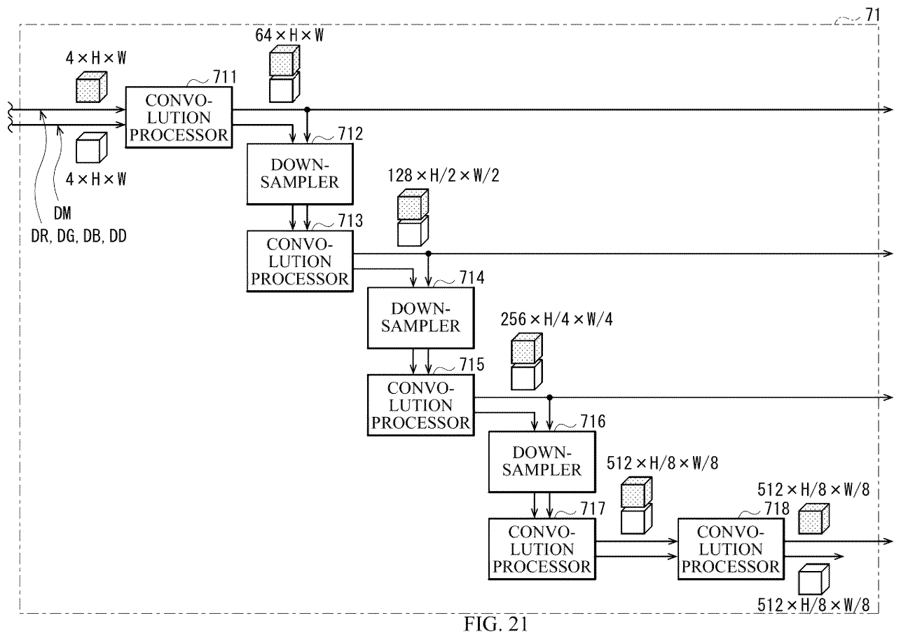

FIG. 21 illustrates a configuration example of the encoder 71. The encoder 71 may include a convolution processor 711, a downsampler 712, a convolution processor 713, a downsampler 714, a convolution processor 715, a downsampler 716, and convolution processors 717 and 718.

The convolution processor 711 may be configured to generate feature quantity data by performing the convolution process, based on the feature quantity data related to the pieces of image data DR, DG, and DB and the depth image data DD, and the control data related to the mask data DM, which are inputted to the encoder 71, and update the control data that has been inputted. For example, the convolution processor 711 may generate the feature quantity data by performing the convolution process on the image part of the feature quantity data related to the pieces of image data DR, DG, and DB and the depth image data DD where no depth value is missing, based on the control data related to the mask data DM. The sizes of the feature quantity data and the control data to be inputted to the convolution processor 711 may each be “4×H×W”, and the sizes of the feature quantity data and the control data to be outputted by the convolution processor 711 may each be “64×H×W”.

The downsampler 712 may be configured to generate feature quantity data and control data by performing the downsampling process, based on the feature quantity data and the control data supplied from the convolution processor 711. The sizes of the feature quantity data and the control data to be outputted by the downsampler 712 may each be “64×H/2×W/2”. The convolution processor 713 may be configured to generate feature quantity data by performing the convolution process, based on the feature quantity data and the control data supplied from the downsampler 712, and update the control data that has been inputted. The sizes of the feature quantity data and the control data to be outputted by the convolution processor 713 may each be “128×H/2×W/2”.

The downsampler 714 may be configured to generate feature quantity data and control data by performing the downsampling process, based on the feature quantity data and the control data supplied from the convolution processor 713. The sizes of the feature quantity data and the control data to be outputted by the downsampler 714 may each be “128×H/4×W/4”. The convolution processor 715 may be configured to generate feature quantity data by performing the convolution process, based on the feature quantity data and the control data supplied from the downsampler 714, and update the control data that has been inputted. The sizes of the feature quantity data and the control data to be outputted by the convolution processor 715 may each be “256×H/4×W/4”.

The downsampler 716 may be configured to generate feature quantity data and control data by performing the downsampling process, based on the feature quantity data and the control data supplied from the convolution processor 715. The sizes of the feature quantity data and the control data to be outputted by the downsampler 716 may each be “256×H/8×W/8”. The convolution processor 717 may be configured to generate feature quantity data by performing the convolution process, based on the feature quantity data and the control data supplied from the downsampler 716, and update the control data that has been inputted. The sizes of the feature quantity data and the control data to be outputted by the convolution processor 717 may each be “512×H/8×W/8”.

The convolution processor 718 may be configured to generate feature quantity data by performing the convolution process, based on the feature quantity data and the control data supplied from the convolution processor 717, and update the control data that has been inputted. The sizes of the feature quantity data and the control data to be outputted by the convolution processor 718 may each be “512×H/8×W/8”.

With the configuration as described above, the encoder 71 may repeat the convolution process, based on the feature quantity data related to the pieces of image data DR, DG, and DB and the depth image data DD, and the control data related to the mask data DM, which are inputted to the encoder 71. As a result, the encoder 71 may compress the image data related to the pieces of image data DR, DG, and DB and the depth image data DD step by step. At this time, the encoder 71 may perform processing on the image part where no depth value is missing, based on the mask data DM. This makes it possible to reduce an influence of the depth value being missing on the feature quantity data. The encoder 71 may be configured to output the four pieces of feature quantity data generated by the convolution processors 711, 713, 715, and 718.

The convolution processors 711, 713, 715, and 718 may include, for example, the convolution processor 320A, 320B, or 320C (FIG. 8A, 8B, or 8C).

Note that any two or more of these modification examples may be combined with each other.

Although some example embodiments and modification examples of the disclosure have been described in the foregoing by way of example with reference to the accompanying drawings, the disclosure is by no means limited to the example embodiments and the modification examples described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the above-described example embodiment, the encoder 31 illustrated in FIG. 6 may be used; however, this example is a non-limiting example, and an encoder having another configuration may be used. In the above-described example embodiment, the encoder 32 illustrated in FIG. 7 may be used; however, this example is a non-limiting example, and an encoder having another configuration may be used. In the above-described example embodiment, the decoder 33 illustrated in FIG. 9 may be used; however, this example is a non-limiting example, and a decoder having another configuration may be used. In the above-described example embodiment, the convolution processor 320A, 320B, or 320C illustrated in FIG. 8A, 8B, or 8C may be used; however, this example is a non-limiting example, and a convolution processor having another configuration may be used.

The example effects described herein are mere examples, and example effects of the disclosure are therefore not limited to those described herein, and other example effects may be achieved.

Furthermore, the disclosure may encompass at least the following embodiments.
(1) An image processing apparatus including:
   an encoder including a first convolution processor, the first convolution processor being configured to generate, based on first feature quantity data and first control data, second feature quantity data by performing a first convolution process on the first feature quantity data,
      the first feature quantity data including captured image data and depth image data,
      the depth image data including map data on a depth value of a subject corresponding to the captured image data,
      the first control data including map data on validity of the depth value corresponding to the depth image data,
   the encoder being configured to generate pieces of feature quantity data including feature quantity data corresponding to the second feature quantity data; and
   a decoder configured to generate, based on the pieces of feature quantity data, an inference result of an environment around an imager that has generated the captured image data.
(2) The image processing apparatus according to (1), in which
   the encoder includes a second convolution processor configured to generate, based on third feature quantity data including the captured image data, fourth feature quantity data by performing a second convolution process on the third feature quantity data, and
   the pieces of feature quantity data includes feature quantity data corresponding to the fourth feature quantity data.
(3) The image processing apparatus according to (1) or (2), in which the first convolution processor is configured to:
   generate multiplication data by multiplying a value in the first feature quantity data and a value in the first control data at coordinate positions corresponding to each other; and
   generate the second feature quantity data by performing the first convolution process, based on the multiplication data.
(4) The image processing apparatus according to (3), in which the first convolution processor is configured to:
   generate second control data by performing a rule-based process, based on the first control data; and
   output the second feature quantity data and the second control data.
(5) The image processing apparatus according to (3), in which the first convolution processor is configured to:
   generate second control data by performing a third convolution process, based on the multiplication data; and
   output the second feature quantity data and the second control data.
(6) The image processing apparatus according to (3), in which the first convolution processor is configured to:
   generate second control data by performing a fourth convolution process on the first control data, based on the first control data; and
   output the second feature quantity data and the second control data.

Each of the image processors 24 and 94 illustrated in FIGS. 3 and 4 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the image processors 24 and 94. Such a medium may take many forms, including, but not limited to, any type of magnetic medium such as a hard disk, any type of optical medium such as a CD and a DVD, any type of semiconductor memory (i.e., semiconductor circuit) such as a volatile memory and a nonvolatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the image processors 24 and 94 illustrated in FIGS. 3 and 4.

1. An image processing apparatus comprising:
an encoder comprising a first convolution processor, the first convolution processor being configured to generate, based on first feature quantity data and first control data, second feature quantity data by performing a first convolution process on the first feature quantity data,
the first feature quantity data comprising captured image data and depth image data,
the depth image data comprising map data on a depth value of a subject corresponding to the captured image data,
the first control data comprising map data on validity of the depth value corresponding to the depth image data,
the encoder being configured to generate pieces of feature quantity data comprising feature quantity data corresponding to the second feature quantity data; and
a decoder configured to generate, based on the pieces of feature quantity data, an inference result of an environment around an imager that has generated the captured image data.

2. The image processing apparatus according to claim 1, wherein
the encoder comprises a second convolution processor configured to generate, based on third feature quantity data comprising the captured image data, fourth feature quantity data by performing a second convolution process on the third feature quantity data, and
the pieces of feature quantity data comprise feature quantity data corresponding to the fourth feature quantity data.

3. The image processing apparatus according to claim 1, wherein the first convolution processor is configured to:
generate multiplication data by multiplying a value in the first feature quantity data and a value in the first control data at coordinate positions corresponding to each other; and
generate the second feature quantity data by performing the first convolution process, based on the multiplication data.

4. The image processing apparatus according to claim 3, wherein the first convolution processor is configured to:
generate second control data by performing a rule-based process, based on the first control data; and
output the second feature quantity data and the second control data.

5. The image processing apparatus according to claim 3, wherein the first convolution processor is configured to:
generate second control data by performing a third convolution process, based on the multiplication data; and
output the second feature quantity data and the second control data.

6. The image processing apparatus according to claim 3, wherein the first convolution processor is configured to:
generate second control data by performing a fourth convolution process on the first control data, based on the first control data; and
output the second feature quantity data and the second control data.
